(19) United States
(12) Patent Application Publication
(10) Pub. No.: US 2019/0363850 A1
(43) Pub. Date: Nov. 28, 2019

(54) METHOD AND DEVICE FOR RECONFIGURING SOUNDING RESOURCES

(71) Applicant: Telefonaktiebolaget LM Ericsson (publ), Stockholm (SE)

(72) Inventor: Rongyan Lin, Sollentuna (SE)

(21) Appl. No.: 16/477,833

(22) PCT Filed: Jan. 18, 2017
(86) PCT No.: PCT/CN2017/071561

§ 371 Date: Jul. 12, 2019

(51) Int. Cl. H04L 5/00

(52) U.S. Cl. CPC H04L 5/0048

(57) ABSTRACT

Embodiments of the disclosure generally relate to a method and device for reconfiguring sounding resources. The method includes: information on reconfiguring a periodicity of sounding reference signals is transmitted to a terminal device via the media access control (MAC) layer. Therefore, sounding resources are reconfigured via the MAC layer and no RRC layer is involved. Therefore, the process of the reconfiguration is relatively simple and the periodicity of sounding reference signals changes quickly. Furthermore, with the method and device, sounding resources could be dynamic adjusted and shared, which could benefit for higher capacity for the scenarios of utilization of SRS.

### TECHNICAL FIELD

Embodiments of the present disclosure generally relate to the field of communications, and more particularly, to a method and device for reconfiguring sounding resources.

### BACKGROUND

Sounding reference signals (SRSs) are transmitted on the uplink and allow the network to estimate the quality of the channel at different frequencies. The SRS is used by the network device (such as an eNB) to estimate the quality of the uplink channel for large bandwidths outside the assigned span to a specific terminal device (such as UE). In long term evolution (LTE), there are big requirements on the sounding resources especially for SRS based beam-forming calculation in full-dimension multiple-input multiple-output (FD-MIMO) and frequency selection scheduling (FSS).

Current SRS configuration could be periodic or aperiodic. For periodic configuration, the sounding resources are allocated in a radio resource control (RRC) signal with bandwidth, frequency domain position, periodicity, cyclic shift etc. While the sounding resources are still limited for some scenario, e.g. SRS based beam-forming in FD-MIMO.

This section introduces aspects that may facilitate a better understanding of the disclosure. Accordingly, the statements of this section are to be read in this light and are not to be understood as admissions about what is in the prior art or what is not in the prior art.

### SUMMARY

The inventor found that in current 3rd Generation Partnership Project (3GPP) there are limited sounding resource in periodic SRS configuration case, which could be one bottleneck in FD-MIMO and FSS. Therefore, the sounding resources need to be reconfigured in some cases. For example, when specific user equipment (UE) does not need sounding, or more capacity is needed, the sounding resources may be reconfigured with a RRC signal at present. However, the process of the reconfiguration is relatively complex and the SRS changes slowly.

In order to solve at least part of the above problems, methods, apparatus, devices, communication systems and computer programs are provided in the present disclosure. It can be appreciated that embodiments of the present disclosure are not limited to a wireless system operating in FD-MIMO, but could be more widely applied to any application scenario where similar problems exist.

Various embodiments of the present disclosure mainly aim at providing methods, devices, communication systems and computer programs for reconfiguring sounding resources between a terminal device and a network device, for example, in a shared frequency band. Other features and advantages of embodiments of the present disclosure will also be understood from the following description of specific embodiments when reading in conjunction with the accompanying drawings, which illustrate, by way of example, the principles of embodiments of the present disclosure.

In general, embodiments of the present disclosure provide a solution for reconfiguring sounding resources.

In a first aspect, a method for reconfiguring sounding resources implemented at a network device is provided. The method includes: information on reconfiguring a periodicity of sounding reference signals is transmitted to a terminal device via the media access control (MAC) layer.

In one embodiment, the information on reconfiguring a periodicity of sounding reference signals is transmitted to the terminal device via a control element of the media access control layer

In one embodiment, the information on reconfiguring a periodicity of sounding reference signals includes a mask.

In one embodiment, the method further includes: information on confirming reconfiguring the periodicity of sounding reference signals is received from the terminal device.

In one embodiment, the method further includes: the sounding reference signals are received with a reconfigured periodicity from the terminal device.

In a second aspect, a method for reconfiguring sounding resources implemented at a terminal device is provided. The method includes: information on reconfiguring a periodicity of sounding reference signals is received from a network device via the media access control (MAC) layer; and the periodicity of sounding reference signals is reconfigured according to the information.

In one embodiment, the information on reconfiguring a periodicity of sounding reference signals includes a mask.

In one embodiment, the periodicity of sounding reference signals is reconfigured according to values of bits of the mask.

In one embodiment, the method further includes: information on confirming reconfiguring the periodicity of sounding reference signals is transmitted to the network device.

In one embodiment, the method further includes: the sounding reference signals with a reconfigured periodicity are transmitted to the network device.

In a third aspect, a network device is provided. The device includes a receiver and a transmitter, and the device further includes: a memory; and a processor configured to perform: transmitting information on reconfiguring a periodicity of sounding reference signals to a terminal device via the media access control (MAC) layer.

In one embodiment, the processor is configured to perform: transmitting the information on reconfiguring a periodicity of sounding reference signals to the terminal device via a control element of the media access control (MAC) layer.

In one embodiment, the information on reconfiguring a periodicity of sounding reference signals includes a mask.

In one embodiment, the processor is further configured to perform: receiving information on confirming reconfiguring the periodicity of sounding reference signals from the terminal device.

In one embodiment, the processor is further configured to perform: receiving the sounding reference signals with a reconfigured periodicity from the terminal device.

In a fourth aspect, a terminal device is provided. The device includes a memory; and a processor configured to perform: receiving information on reconfiguring a periodicity of sounding reference signals from a network device via the media access control (MAC) layer; and reconfiguring the periodicity of sounding reference signals according to the information.

In one embodiment, the information on reconfiguring a periodicity of sounding reference signals includes a mask.

In one embodiment, the processor is configured to perform: reconfiguring the periodicity of sounding reference signals according to values of bits of the mask.

In one embodiment, the processor is further configured to perform: transmitting information on confirming reconfiguring the periodicity of sounding reference signals to the network device.

In one embodiment, the processor is further configured to perform: transmitting the sounding reference signals with a reconfigured periodicity to the network device.

In a fifth aspect, a communication system is provided. The communication system includes: a network device according to the third aspect; and a terminal device according to the fourth aspect.

In a sixth aspect, a computer program product is provided. The computer program product is tangibly stored on a computer readable storage medium and includes instructions which, when executed on a processor of a network device, cause the network device to perform a method for reconfiguring sounding resources according to the first aspect.

In a seventh aspect, a computer program product is provided. The computer program product is tangibly stored on a computer readable storage medium and includes instructions which, when executed on a processor of a terminal device, cause the network device to perform a method for reconfiguring sounding resources according to the second aspect.

According to various embodiments of the present disclosure, sounding resources are reconfigured via the MAC layer and no RRC layer is involved. Therefore, the process of the reconfiguration is relatively simple and the periodicity of sounding reference signals changes quickly. Furthermore, sounding resources could be dynamic adjusted and shared, which could benefit for higher capacity for the scenarios of utilization of SRS.

### BRIEF DESCRIPTION OF THE DRAWINGS

The above and other aspects, features, and benefits of various embodiments of the disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 shows a schematic diagram 100 of a wireless communication network;

FIG. 2 shows an example of sounding reference signals transmitted by the terminal device;

FIG. 3 shows a diagram of reconfiguring sounding resources 300 in accordance with an embodiment of the present disclosure;

FIG. 4 shows an example of the mask window included in the information;

FIG. 5 shows another diagram of reconfiguring sounding resources 500 in accordance with an embodiment of the present disclosure;

FIG. 6 shows an example of how the mask window changing the periodicity of sounding reference signals;

FIG. 7 shows an example of reconfigured sounding reference signals transmitted by the terminal device;

FIG. 8 shows another diagram of reconfiguring sounding resources 800 in accordance with an embodiment of the present disclosure;

FIG. 9 shows a block diagram of the network device 900 in accordance with an embodiment of the present disclosure;

FIG. 10 shows a block diagram of the terminal device 1000 in accordance with an embodiment of the present disclosure;

FIG. 11 shows a simplified block diagram of a device 1100 that is suitable for implementing embodiments of the present disclosure

### DETAILED DESCRIPTION

The present disclosure will now be discussed with reference to several example embodiments. It should be understood that these embodiments are discussed only for the purpose of enabling those skilled persons in the art to better understand and thus implement the present disclosure, rather than suggesting any limitations on the scope of the present disclosure.

As used herein, the term “wireless communication network” refers to a network following any suitable communication standards, such as LTE-Advanced (LTE-A), LTE, Wideband Code Division Multiple Access (WCDMA), High-Speed Packet Access (HSPA), and so on. Furthermore, the communications between a terminal device and a network device in the wireless communication network may be performed according to any suitable generation communication protocols which support SRS, including, but not limited to, the fourth generation (4G), 4.5G, the future fifth generation (5G) communication protocols, and/or any other protocols either currently known or to be developed in the future.

The term “network device” refers to a device in a wireless communication network via which a terminal device accesses the network and receives services therefrom. The network device refers a base station (BS), an access point (AP), a Mobile Management Entity (MME), Multi-cell/Multicast Coordination Entity (MCE), a gateway, a server, a controller or any other suitable device in the wireless communication network. The BS may be, for example, a node B (NodeB or NB), an evolved NodeB (eNodeB or eNB), a Remote Radio Unit (RRU), a radio header (RH), a remote radio head (RRH), a relay, a low power node such as a femto, a pico, and so forth.

Yet further examples of network device include multi-standard radio (MSR) radio equipment such as MSR BSs, network controllers such as radio network controllers (RNCs) or base station controllers (BSCs), base transceiver stations (BTSs), transmission points, transmission nodes, Multi-cell/multicast Coordination Entities (MCEs), core network nodes (e.g., MSCs, MMEs), O&M nodes, OSS nodes, SON nodes, positioning nodes (e.g., E-SMLCs), and/or MDTs. More generally, however, network device may represent any suitable device (or group of devices) capable, configured, arranged, and/or operable to enable and/or provide a terminal device access to the wireless communication network or to provide some service to a terminal device that has accessed the wireless communication network.

The term “terminal device” refers to any end device that can access a wireless communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

The terminal device may support device-to-device (D2D) communication, for example by implementing a 3GPP standard for sidelink communication, and may in this case be referred to as a D2D communication device.

As yet another specific example, in an Internet of Things (IoT) scenario, a terminal device may represent a machine or other device that performs monitoring and/or measurements, and transmits the results of such monitoring and/or measurements to another terminal device and/or a network equipment. The terminal device may in this case be a machine-to-machine (M2M) device, which may in a 3GPP context be referred to as a machine-type communication (MTC) device.

As one particular example, the terminal device may be a UE implementing the 3GPP narrow band internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment that is capable of monitoring and/or reporting on its operational status or other functions associated with its operation.

In this disclosure, a device can be a network or a terminal device. That is, a method for reconfiguring sounding resources of the disclosure can be implemented at the network device and the terminal device.

In this disclosure, the sounding resources include at least one of spectrum resources, time resources, and space resources, and this disclosure is described taking the time resource as an example. For example, in time division duplexing (TDD) systems, the sounding resources refer to time resources. However, a type of the resources is not limited in this disclosure.

As used herein, the terms “first” and “second” refer to different elements. The singular forms “a” and “an” are intended to include the plural forms as well, unless the context clearly indicates otherwise. The terms “comprises,” “comprising,” “has,” “having,” “includes” and/or “including” as used herein, specify the presence of stated features, elements, and/or components and the like, but do not preclude the presence or addition of one or more other features, elements, components and/or combinations thereof. The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below.

The term “weighting” or “weights”, when used in this disclosure, please refers to LTE/LTE-A specification, such as Rel.12. For example, weights are some parameters (or values, coefficients, and so on) of the weighting. The beamforming can be found in some specifications, such as https://en.wikipedia.org/wiki/ Beamforming, but it is not limited thereto.

Now some exemplary embodiments of the present disclosure will be described below with reference to the figures.

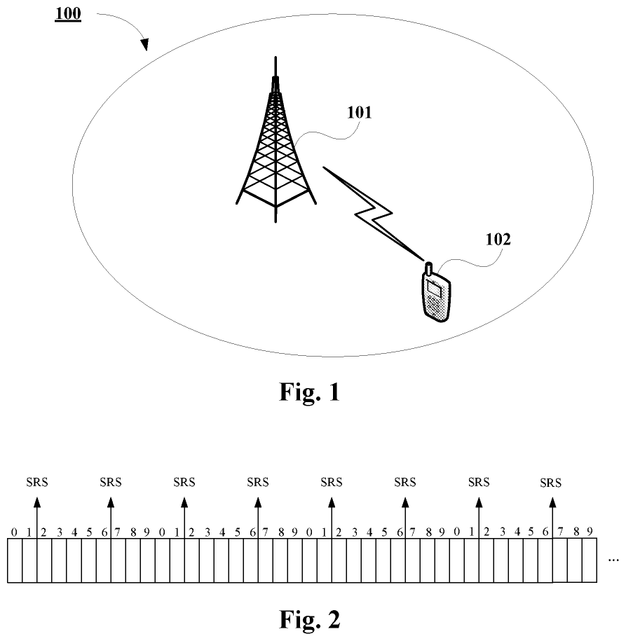

Reference is first made to FIG. 1, which shows a schematic diagram 100 of a wireless communication network. There illustrates a network device 101 and a terminal device 102 in the wireless communication network. In the example of FIG. 1, the network device 101 provides service to the terminal device 102. The traffic between the network device 101 and the terminal device 102 may be URLLC traffic, eMBB traffic, mMTC traffic, and so on.

It is to be understood that the configuration of FIG. 1 is described merely for the purpose of illustration, without suggesting any limitation as to the scope of the present disclosure. Those skilled in the art would appreciate that the wireless communication network 100 may include any suitable number of terminal devices and/or network devices and may have other suitable configurations.

FIG. 2 shows an example of sounding reference signals transmitted by the terminal device. As shown in FIG. 2, the periodicity of sounding reference signals is 5 ms.

### A First Embodiment

A method for reconfiguring sounding resources is provided in this embodiment. The method is implemented at a network device.

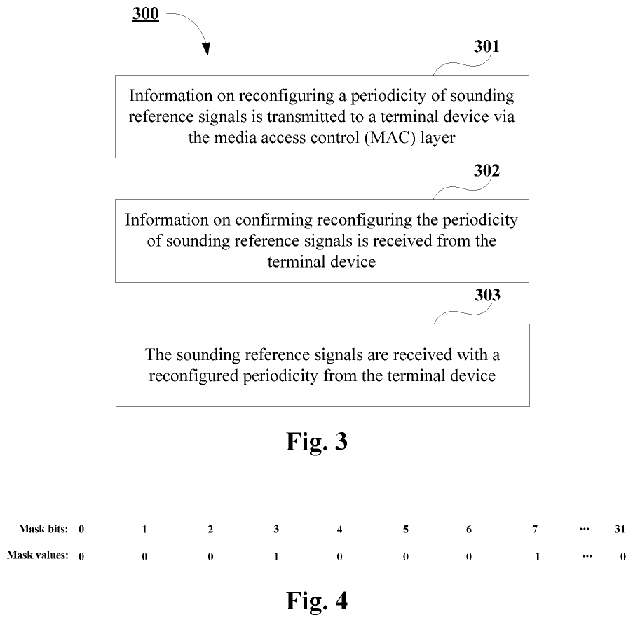

FIG. 3 shows a diagram of reconfiguring sounding resources 300 in accordance with an embodiment of the present disclosure, and illustrates the method for transmitting information from a viewpoint of the network device. As shown in FIG. 3, the method includes:

Block 301, information on reconfiguring a periodicity of sounding reference signals is transmitted to a terminal device via the media access control (MAC) layer;

Block 302, information on confirming reconfiguring the periodicity of sounding reference signals is received from the terminal device; and

Block 303, the sounding reference signals are received with a reconfigured periodicity from the terminal device.

In this embodiment, the network device may decide to reconfigure the sounding resources according to some specific schemes. For example, when specific user equipment (UE) does not need sounding, or more capacity is needed, the network device decides to reconfigure the sounding resources and transmits information on reconfiguring a periodicity of sounding reference signals via the MAC layer.

In this embodiment, the information on reconfiguring a periodicity of sounding reference signals may be transmitted to the terminal device via a control element (CE) of the MAC layer. For example, a message including the information on reconfiguring a periodicity of sounding reference signals is transmitted via a CE of the MAC layer.

In this embodiment, the information on reconfiguring a periodicity of sounding reference signals may include a mask to change the periodicity of sounding reference signals, such as a mask window with specific bits and the value of each bit is 0 or 1. For example, the length of the mask window may be 32 bits. However, it is not limited thereto, for example, the length of the mask window and the value of each bit may be set according to actual situations.

FIG. 4 shows an example of the mask window included in the information. As shown in FIG. 4, the mask window is a 32-bits mask window, and the values of all bits are 0, 0, 0, 1, 0, 0, 0, 1, . . . , 0, 0, 0, 1.

In this embodiment, when the terminal device receive the information on reconfiguring a periodicity of sounding reference signals and changes the periodicity of sounding reference signals, the terminal transmits information on confirming reconfiguring the periodicity of sounding reference signals to the network device via a message, such as a hybrid automatic repeat request (HARQ) AN and/or an additional confirmation message.

In this embodiment, after the information on confirming reconfiguring the periodicity of sounding reference signals is received, the sounding reference signals are received with a reconfigured periodicity from the terminal device.

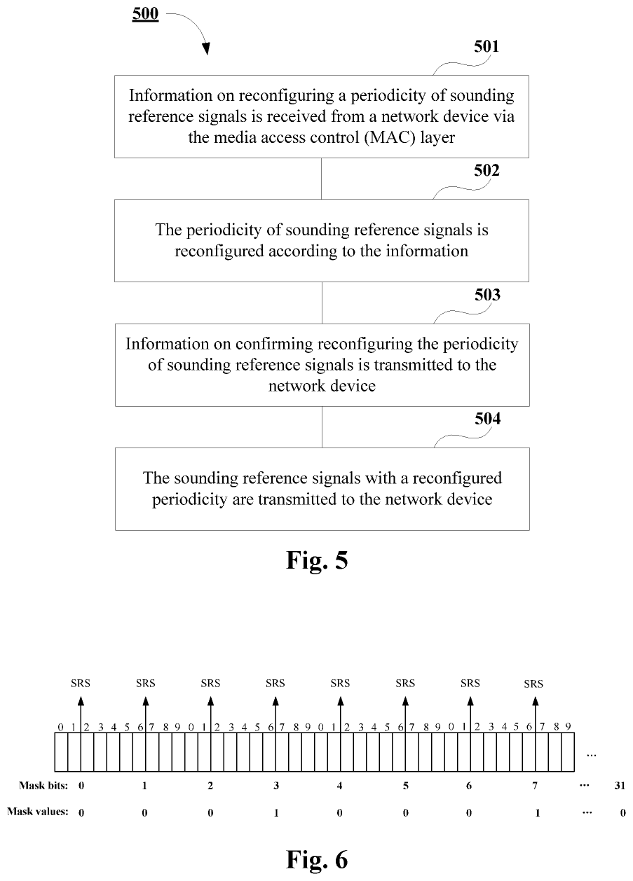

FIG. 5 shows another diagram of reconfiguring sounding resources 500 in accordance with an embodiment of the present disclosure, and illustrates the method for transmitting information from a viewpoint of the terminal device. As shown in FIG. 5, the method includes:

Block 501, information on reconfiguring a periodicity of sounding reference signals is received from a network device via the media access control (MAC) layer;

Block 502, the periodicity of sounding reference signals is reconfigured according to the information;

Block 503, information on confirming reconfiguring the periodicity of sounding reference signals is transmitted to the network device; and

Block 504, the sounding reference signals with a reconfigured periodicity are transmitted to the network device.

In this embodiment, before the terminal device receives the information and reconfigures the periodicity of sounding reference signals, the terminal device may be given the authority of reconfiguring the periodicity of sounding reference signals. For example, a bit of FRG may be defined.

In this embodiment, the terminal device receives the information on reconfiguring the periodicity of sounding reference signals via the MAC layer. For example, the information on reconfiguring the periodicity of sounding reference signals includes a mask, such as a mask window shown in FIG. 4.

In this embodiment, the terminal device reconfigures the periodicity of sounding reference signals according to values of bits of the mask.

FIG. 6 shows an example of how the mask window changing the periodicity of sounding reference signals. As shown in FIG. 6, each bit of the mask corresponds to each SRS in time series. When the value of a bit is 0, the corresponding SRS is set to be invalid, and when the value of a bit is 1, the corresponding SRS is set to be valid. That is, the terminal device does not transmit a SRS where the value of the corresponding bit is 0 and transmit a SRS where the value of the corresponding bit is 1. The resources where SRS transmitted no longer are released, and more resource can be allocated to other terminal devices.

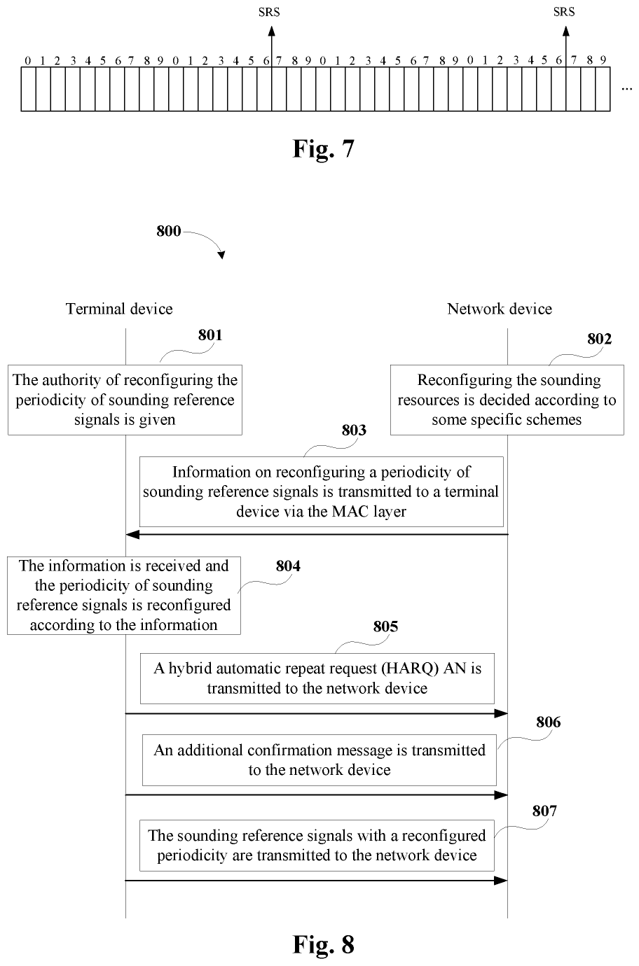

FIG. 7 shows an example of reconfigured sounding reference signals transmitted by the terminal device. As shown in FIG. 7, the periodicity of sounding reference signals is changes from 5 ms to 20 ms.

Therefore, the periodicity of sounding reference signals is changed quickly, and SRS resources could be scaled up dynamically.

FIG. 8 shows another diagram of reconfiguring sounding resources 800 in accordance with an embodiment of the present disclosure, and illustrates the method for reconfiguring sounding resources from viewpoints of the terminal device and the network device. As shown in FIG. 8, the method includes:

Block 801, the authority of reconfiguring the periodicity of sounding reference signals is given;

Block 802, reconfiguring the sounding resources is decided according to some specific schemes;

Block 803, information on reconfiguring a periodicity of sounding reference signals is transmitted to a terminal device via the MAC layer;

Block 804, the information is received and the periodicity of sounding reference signals is reconfigured according to the information.

Block 805, a hybrid automatic repeat request (HARQ) AN is transmitted to the network device;

Block 806, an additional confirmation message is transmitted to the network device;

Block 807, the sounding reference signals with a reconfigured periodicity are transmitted to the network device.

As can be seen from the above embodiment, sounding resources are reconfigured via the MAC layer and no RRC layer is involved. Therefore, the process of the reconfiguration is relatively simple and the periodicity of sounding reference signals changes quickly. Furthermore, sounding resources could be dynamic adjusted and shared, which could benefit for higher capacity for the scenarios of utilization of SRS.

### A Second Embodiment

A network device is provided in this embodiment, and the same contents as those in the first embodiment are omitted.

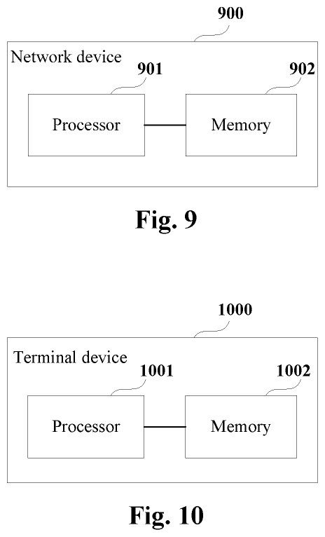

FIG. 9 shows a block diagram of the network device 900 in accordance with an embodiment of the present disclosure. As shown in FIG. 9, the network device 900 includes a processor 901 and a memory 902, the processor is configured to perform: transmitting information on reconfiguring a periodicity of sounding reference signals to a terminal device via the media access control (MAC) layer, the memory 902 is configured to store any data.

In this embodiment, the processor 901 is configured to perform: transmitting the information on reconfiguring a periodicity of sounding reference signals to the terminal device via a control element of the MAC layer.

In this embodiment, the information on reconfiguring a periodicity of sounding reference signals includes a mask.

In this embodiment, the processor 901 is further configured to perform: receiving information on confirming reconfiguring the periodicity of sounding reference signals from the terminal device.

In this embodiment, the processor 901 is further configured to perform: receiving the sounding reference signals with a reconfigured periodicity from the terminal device.

It should be appreciated that functions of the processor 901 in the network device 900 correspond to the operations of the method 300. Therefore, all operations and features described above with reference to FIG. 3 are likewise applicable to the processor 901 in the network device 900 and have similar effects. For the purpose of simplification, the details will be omitted.

As can be seen from the above embodiment, sounding resources are reconfigured via the MAC layer and no RRC layer is involved. Therefore, the process of the reconfiguration is relatively simple and the periodicity of sounding reference signals changes quickly. Furthermore, sounding resources could be dynamic adjusted and shared, which could benefit for higher capacity for the scenarios of utilization of SRS.

### A Third Embodiment

A terminal device is provided in this embodiment, and the same contents as those in the first embodiment are omitted.

FIG. 10 shows a block diagram of the terminal device 1000 in accordance with an embodiment of the present disclosure. As shown in FIG. 10, the terminal device 1000 includes a processor 1001 and a memory 1002, the processor is configured to perform: receiving information on reconfiguring a periodicity of sounding reference signals from a network device via the media access control (MAC) layer; and reconfiguring the periodicity of sounding reference signals according to the information, the memory 1002 is configured to store any data.

In this embodiment, the information on reconfiguring a periodicity of sounding reference signals includes a mask.

In this embodiment, the processor 1001 is configured to perform: reconfiguring the periodicity of sounding reference signals according to values of bits of the mask.

In this embodiment, the processor 1001 is further configured to perform: transmitting information on confirming reconfiguring the periodicity of sounding reference signals to the network device.

In this embodiment, the processor 1001 is further configured to perform: transmitting the sounding reference signals with a reconfigured periodicity to the network device.

It should be appreciated that functions of the processor 1001 in the terminal device 1000 correspond to the operations of the method 500. Therefore, all operations and features described above with reference to FIG. 5 are likewise applicable to the processor 1001 in the network device 1000 and have similar effects. For the purpose of simplification, the details will be omitted.

As can be seen from the above embodiment, sounding resources are reconfigured via the MAC layer and no RRC layer is involved. Therefore, the process of the reconfiguration is relatively simple and the periodicity of sounding reference signals changes quickly. Furthermore, sounding resources could be dynamic adjusted and shared, which could benefit for higher capacity for the scenarios of utilization of SRS.

### A Fourth Embodiment

A terminal device and a network device are provided in this embodiment, and the same contents as those in the first to fourth embodiments are omitted.

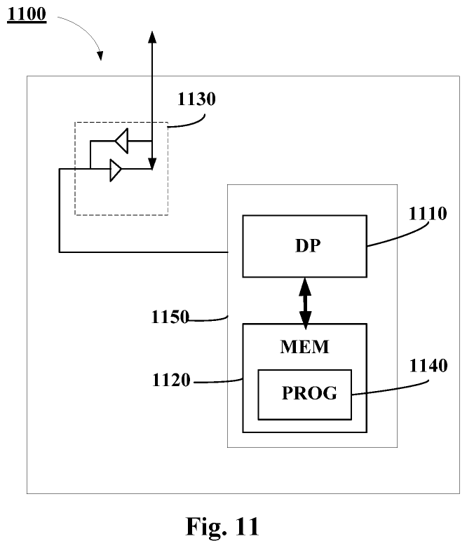

FIG. 11 shows a simplified block diagram of a device 1100 that is suitable for implementing embodiments of the present disclosure. It would be appreciated that the device 1100 may be implemented as at least a part of, for example, the network device 900 or the terminal device 1000.

As shown, the device 1100 includes a communicating means 1130 and a processing means 1150. The processing means 1150 includes a data processor (DP) 1110, a memory (MEM) 1120 coupled to the DP 1110. The communicating means 1130 is coupled to the DP 1110 in the processing means 1150. The MEM 1120 stores a program (PROG) 1140. The communicating means 1130 is for communications with other devices, which may be implemented as a transceiver for transmitting/receiving signals.

In some embodiments where the device 1100 acts as a network device, the processing means 1150 may be configured to perform: transmitting information on reconfiguring a periodicity of sounding reference signals to a terminal device via the media access control (MAC) layer. In some other embodiments where the device 1100 acts as a terminal device, the processing means 1150 may be configured to perform: receiving information on reconfiguring a periodicity of sounding reference signals from a network device via the media access control (MAC) layer; and reconfiguring the periodicity of sounding reference signals according to the information.

The PROG 1140 is assumed to include program instructions that, when executed by the associated DP 1110, enable the device 1100 to operate in accordance with the embodiments of the present disclosure, as discussed herein with the method 300, 500 or 800. The embodiments herein may be implemented by computer software executable by the DP 1110 of the device 1100, or by hardware, or by a combination of software and hardware. A combination of the data processor 1110 and MEM 1120 may form processing means 1150 adapted to implement various embodiments of the present disclosure.

The MEM 1120 may be of any type suitable to the local technical environment and may be implemented using any suitable data storage technology, such as semiconductor based memory devices, magnetic memory devices and systems, optical memory devices and systems, fixed memory and removable memory, as non-limiting examples. While only one MEM is shown in the device 1100, there may be several physically distinct memory modules in the device 1100. The DP 1110 may be of any type suitable to the local technical environment, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

As can be seen from the above embodiment, sounding resources are reconfigured via the MAC layer and no RRC layer is involved. Therefore, the process of the reconfiguration is relatively simple and the periodicity of sounding reference signals changes quickly. Furthermore, sounding resources could be dynamic adjusted and shared, which could benefit for higher capacity for the scenarios of utilization of SRS.

### A Fifth Embodiment

A communication system is provided in this embodiment, wherein, the system includes a network device and at least one terminal device, the network device can be achieved by network device 900 or 1100 in the second and fourth embodiments, the terminal device can be achieved by terminal device 1000 or 1100 in the third and fourth embodiments, and the same contents as those in the first to fifth embodiments are omitted.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or another computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

By way of example, embodiments of the present disclosure can be described in the general context of machine-executable instructions, such as those included in program modules, being executed in a device on a target real or virtual processor. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. The machine readable medium may include but not limited to an electronic, magnetic, optical, electromagnetic, infrared, or semiconductor system, apparatus, or device, or any suitable combination of the foregoing.

More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

In the context of this disclosure, the device may be implemented in the general context of computer system-executable instructions, such as program modules, being executed by a computer system. Generally, program modules may include routines, programs, objects, components, logic, data structures, and so on that perform particular tasks or implement particular abstract data types. The device may be practiced in distributed cloud computing environments where tasks are performed by remote processing devices that are linked through a communications network. In a distributed cloud computing environment, program modules may be located in both local and remote computer system storage media including memory storage devices.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method for reconfiguring sounding resources, the method comprising:
transmitting information on reconfiguring a periodicity of sounding reference signals to a terminal device via the media access control (MAC) layer.

2. The method according to claim 1, wherein,
transmitting the information on reconfiguring a periodicity of sounding reference signals to the terminal device via a control element of the media access control layer.

3. The method according to claim 1, wherein the information on reconfiguring a periodicity of sounding reference signals comprising a mask.

4. The method according to claim 1, wherein the method further comprising:
receiving information on confirming reconfiguring the periodicity of sounding reference signals from the terminal device.

5. The method according to claim 1, wherein the method further comprising:
receiving the sounding reference signals with a reconfigured periodicity from the terminal device.

6. A method for reconfiguring sounding resources, the method comprising:
receiving information on reconfiguring a periodicity of sounding reference signals from a network device via the media access control (MAC) layer; and
reconfiguring the periodicity of sounding reference signals according to the information.

7. The method according to claim 6, wherein the information on reconfiguring a periodicity of sounding reference signals comprising a mask.

8. The method according to claim 7, wherein,
reconfiguring the periodicity of sounding reference signals according to values of bits of the mask.

9. The method according to claim 6, wherein the method further comprising:
transmitting information on confirming reconfiguring the periodicity of sounding reference signals to the network device.

10. The method according to claim 6, wherein the method further comprising:
transmitting the sounding reference signals with a reconfigured periodicity to the network device.

11. A network device, comprising:
a memory; and
a processor configured to perform:
transmitting information on reconfiguring a periodicity of sounding reference signals to a terminal device via the media access control (MAC) layer.

12. The device according to claim 11, wherein the processor configured to perform:
transmitting the information on reconfiguring a periodicity of sounding reference signals to the terminal device via a control element of the media access control layer.

13. The device according to claim 11, wherein the information on reconfiguring a periodicity of sounding reference signals comprising a mask.

14. The device according to claim 11, wherein the processor further configured to perform:
receiving information on confirming reconfiguring the periodicity of sounding reference signals from the terminal device.

15. The device according to claim 11, wherein the processor further configured to perform:
receiving the sounding reference signals with a reconfigured periodicity from the terminal device.

16. A terminal device, comprising:
a memory; and
a processor configured to perform:
receiving information on reconfiguring a periodicity of sounding reference signals from a network device via the media access control (MAC) layer; and
reconfiguring the periodicity of sounding reference signals according to the information.

17. The device according to claim 16, wherein the information on reconfiguring a periodicity of sounding reference signals comprising a mask.

18. The device according to claim 17, wherein the processor configured to perform:
reconfiguring the periodicity of sounding reference signals according to values of bits of the mask.

19. The device according to claim 16, wherein the processor further configured to perform:
transmitting information on confirming reconfiguring the periodicity of sounding reference signals to the network device.

20. The device according to claim 16, wherein the processor further configured to perform:
transmitting the sounding reference signals with a reconfigured periodicity to the network device.

21. (canceled)

22. A computer program product being tangibly stored on a computer readable storage medium and comprising instructions which, when executed on a processor of a network device, cause the network device to transmit information on reconfiguring a periodicity of sounding reference signals to a terminal device via the media access control (MAC) layer.

23. A computer program product being tangibly stored on a computer readable storage medium and comprising instructions which, when executed on a processor of a terminal device, cause the network device to:
receive information on reconfiguring a periodicity of sounding reference signals from a network device via the media access control (MAC) layer; and
reconfigure the periodicity of sounding reference signals according to the information.
